(19) United States
(12) Patent Application Publication
(10) Pub. No.: US 2014/0333012 A1
(43) Pub. Date: Nov. 13, 2014

(54) METHOD OF MANUFACTURING A HEARING AID COMPONENT

(71) Applicant: Phonak AG, Stäfa (CH)

(72) Inventors: Matthias Riepenhoff, Zurich (CH); Axel Schlesinger, Stafa (CH)

(73) Assignee: Phonak AG

(21) Appl. No.: 14/372,551

(22) PCT Filed: Jan. 17, 2012
(86) PCT No.: PCT/EP2012/050634

§ 371 Date: Jul. 16, 2014

(51) Int. Cl. H04R 25/00; B29C 67/00

(52) U.S. Cl. CPC H04R 25/658; B29C 67/0059; B29L 2031/753
USPC 264/401; 264/259; 264/265; 264/494

(57) ABSTRACT

A method of manufacturing a hearing aid component (24, 25, 30, 32, 34), having the steps of providing a substrate component (23); and applying a functional structure (22) of a viscoelastic material having a thickness of at least 50 μm onto a surface of the substrate component by an inkjet printing process utilizing a jet of droplets (18) having a volume from 0.1 nl to 10 nl. The hardness of the functional structure is lower than the hardness of the substrate component.

### BACKGROUND OF THE INVENTION

1. Field of the Invention

The invention relates to a method of manufacturing a hearing aid component, such as a part of a hearing aid housing.

2. Description of Related Art

Hearing aids are miniaturized devices which incorporate electronic, mechanical and electrochemical components such as microphones, loudspeakers, coils, switches, processors, amplifiers, various kinds of sensors, electrical connectors and batteries in a housing. These components require seals against humidity and dirt and damping structures against shock and vibrations in order to prevent failure of the components and improve performance of the device. Hearing aid loudspeakers are also called receivers. Typically, receivers and microphones have hard, metallic housings and require damping structures to be mechanically isolated from their surrounding in order to reduce feedback. Receivers and microphones are vibration sensitive components. The problem of feedback caused by vibration is due to the fact that during normal operation of the hearing aid the receiver is outputting an amplified signal of the microphone of the hearing aid. Since vibrations are transmitted between components which are in close mechanical contact also these components are considered to be vibration sensitive. Therefore, a housing of a hearing aid or a part of a hearing aid which contains a receiver or a microphone is vibration sensitive.

Examples for non-vibration sensitive components are, for example, earpieces which do not contain receivers or microphones.

Switches and battery compartments comprise movable mechanical parts which may cause openings to the inner parts of a hearing aid housing and therefore require adequate sealing against humidity and dirt. Since all electronic components are humidity sensitive also such mechanical components are regarded as to be humidity sensitive components.

Usually, such seals and damping structures are made of a soft material and are located on a curved substrate made of a harder material, such as a hard plastic material or a ceramic material. Typically, the housing of a hearing aid containing such components is manufactured by an injection molding process. Seals and damping structures on some areas of the housing can be created contemporarily when a two-component injection molding process is applied. However, often such process is not easy to control and the required tools are expensive. Further, the capability of injection molding processes to create fine structures is limited. The choice of acceptable soft performing material which can be processed in a two-component injection molding process is limited.

The raw material for the injection molding process may contain additional non-organic materials like powders of metals or glas to reach specific optical, electrical or mechanical properties. For creation of ceramic materials, an additional sintering step might be necessary, a contemporary creation of damping structures is not possible.

It is known that three-dimensional structures can be produced by inkjet printing. Such 3D inkjet printing is an additive manufacturing process which is typically used for rapid prototyping. For example, a 3D printing system may generate a 3D prototype based on data provided by a CAD system. Such 3D printing systems are already commercially available, for example, from the company Objet Geometries or from the company Z Corporation.

It has been proposed to use a 3D inkjet printing process for manufacturing hearing instrument earpieces, see for example, U.S. Patent Application Publications 2010/0017006 A1, ]2007/0116311 A1, US 2004/0107080 A1 corresponding to U.S. Pat. No. 8,032,337 B2, and UK Patent Application Publication GB 2344556 A, and U.S. Pat. No. 7,660,427 B2.

U.S. Patent Application Publication 2008/0070181 A1 and corresponding U.S. Pat. No. 8,291,912 B2 relate to an oral appliance used for coupling sound from a hearing instrument into a tooth, which oral appliance may be manufactured by using a 3D inkjet printing process.

International Patent Application Publication WO 2011/000375 A1 relates to an earplug of a receiver-in-the-ear-hearing aid, which earplug comprises a shell individually shaped according to the measured shape of the user's ear. The outer surface of the shell is provided with electrodes for measuring brain wave signals. The electrodes are applied onto the shell by an inkjet printing process using conductive ink.

### SUMMARY OF THE INVENTION

It is an object of the invention to provide a method of manufacturing a hearing aid component, which is cost effective, which has as little geometrical and topological constraints as possible, which is easy to control and which is highly flexible in case of design changes and has better acoustical and mechanical properties and allows to combine multiple functions in one component.

According to the invention, this object is achieved by a method as described herein.

The invention is beneficial in that, by applying, by an inkjet printing process utilizing a jet of droplets having a volume from 0.1 nl to 10 nl, a functional structure of a viscoelastic material having a thickness of at least 50 μm onto a surface of a substrate component, a relatively hard substrate can be provided with a relatively soft functional structure in a simple, effective and contactless manner. The method of the invention has only little constraints regarding the geometry and topology of the functional structure and is highly flexible in case of redesign of the hearing aid component. In particular, such manufacturing method may replace a two-component injection molding process, thereby saving the costs resulting from the tools required for injection molding. Thus, the manufacturing method according to the invention is particularly suited for small series and for individually shaped components.

Moreover, the invention is also suitable for modification of existing components like receivers, microphones, coils, switches or knobs. The inventive method offers the possibility to apply a damping or sealing structure on such a component instead of creating it inside the hearing aid shell. This alternative process creates a damping structure between the hearing aid shell and a receiver or microphone or another vibration sensitive component.

Hereinafter, examples of the invention will be illustrated by reference to the accompanying drawings.

### BRIEF DESCRIPTION OF THE DRAWINGS

FIG. 1 is a schematic view of an inkjet printing setup for applying a functional structure onto a substrate;

FIG. 2A is a schematic side sectional view of a part of a receiver housing of a hearing aid comprising vibration damping structures;

FIG. 2B is a top view of the part shown in FIG. 2A;

FIG. 2C is a schematic view of the part shown in FIGS. 2A & 2B during manufacturing;

FIG. 3 is a side sectional view of several hearing aid components, wherein areas to be provided with a viscoelastic functional structure are marked by arrows; and

FIG. 4 is a perspective view of hearing aid components, wherein areas to be provided with viscoelastic functional structures are marked by arrows.

### DETAILED DESCRIPTION OF THE INVENTION

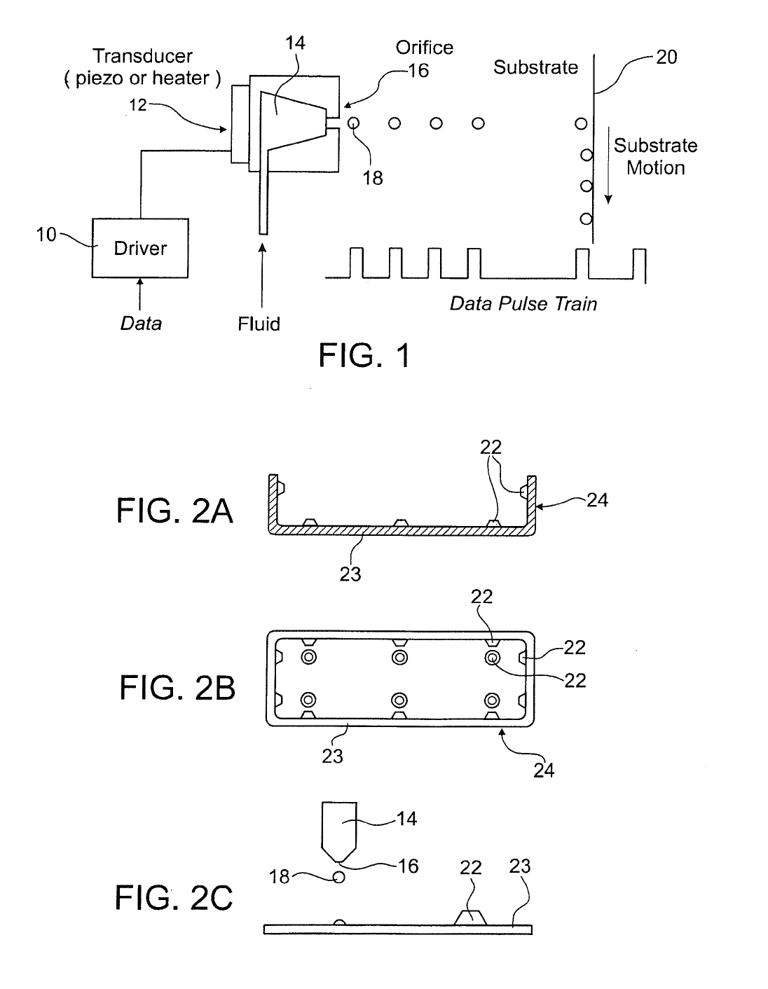

In FIG. 1 a system for applying 3D structures onto a substrate by inkjet printing is shown schematically. The printer system comprises a driver 10 which drives a transducer 12 (such as a piezotransducer or a heater) according to data supplied at the input of the driver 10, a fluid reservoir 14 and an orifice (i.e., a nozzle) 16. Fluid is supplied to the fluid reservoir 14 at ambient pressure, and the transducer 12 acts on the fluid in the fluid reservoir 14 in such a manner that a droplet 18 is ejected through the orifice 16 when the driver 10 has received a corresponding data pulse. The droplets 18 are ejected towards a substrate surface 20 which moves into a direction perpendicular to the jet of droplets 18. The droplets 18 of the jet of the inkjet printing process according to the invention have a volume from 0.1 nl to 10 nl.

Three-dimensional structures can be created, for example, by scanning the substrate surface 20 repeatedly in such a manner that the structures are built up layer-by-layer (i.e., each point of the substrate surface area 20 is brought several times into the jet of droplets 18; in FIG. 1 the generation of the first layer of the structure is shown).

An example of the generation of a 3D structure is illustrated in FIG. 2C, wherein several bump-shaped functional structures 22 are applied onto a substrate component 23 in order to produce a part 24 of a hearing aid speaker housing. The functional structures 22 are designed to act as damping elements. A side view and a top view of the speaker housing part 24 after manufacturing are shown in FIGS. 2A and 2B, respectively.

The substrate component may be, for example, a polymer or a glass reinforced polymer. It may also be made of a metal or a ceramic, or it may contain metallic and/or ceramic materials.

The substrate component is typically produced by an injection molding process and is preferably made of a relatively hard plastics material or of a ceramic material.

Alternatively, the substrate may be made of metal, for example, a receiver or a microphone.

The hardness of synthetic or metallic substrate material may be classified in accordance with the Vickers scale; if the material is a metal, it may have a hardness ranging from 10 to 3000 HV 3; for plastic materials the hardness may range from 1 to 10000 HV 0.01.

In view of the fact that injection molding processes often produce surfaces of relatively low roughness, it may be necessary to apply a surface treatment to the surface of the substrate component prior to applying the functional structure. For example, the surface of the substrate component may be activated and/or conditioned by irradiation, such as x-rays, accelerated electrons, UV laser light, visible laser light or IR laser light, prior to applying the functional structure. However, also other surface treatment, in particular, for roughening the surface of the substrate component, may be applied. Preferably, the surface of the substrate component has a surface roughness of with an Ra value between 12 to 33 according to VDE 3400 prior to applying the functional structure.

The functional structure, after having been applied onto the substrate component, may be cured by applying heat or radiation.

The functional structures have a thickness of at least 50 μm and preferably not more than 500 μm.

The hardness of the functional structures is lower than the hardness of the substrate component. The functional structures are made of a viscoelastic material which preferably has a hardness in the range of 10-80 Shore A.

For example, the material of the functional structures may be polyamide 6.6, polyamide 12, propylene, polyurethane, pebax, TPE, a silicone compound or an acryl material.

In FIG. 2 an example is shown wherein the functional structures are designed to act as a vibration damping and shock absorbing element. According to other examples, the functional structures may be designed to act as seals.

According to the example of FIGS. 2A-2C, the component provided with the functional structures is a housing part of a hearing aid loudspeaker. However, also other components of hearing aid may be provided with such functional structures, for example, a housing part of the hearing aid, a part of a hearing aid ear-hook, a part of a control element for manual control of a hearing aid, a housing part of a hearing aid microphone, a part of a hearing aid circuitry, or a hearing aid audio shoe. Also receivers or microphones may be provided with the functional structure.

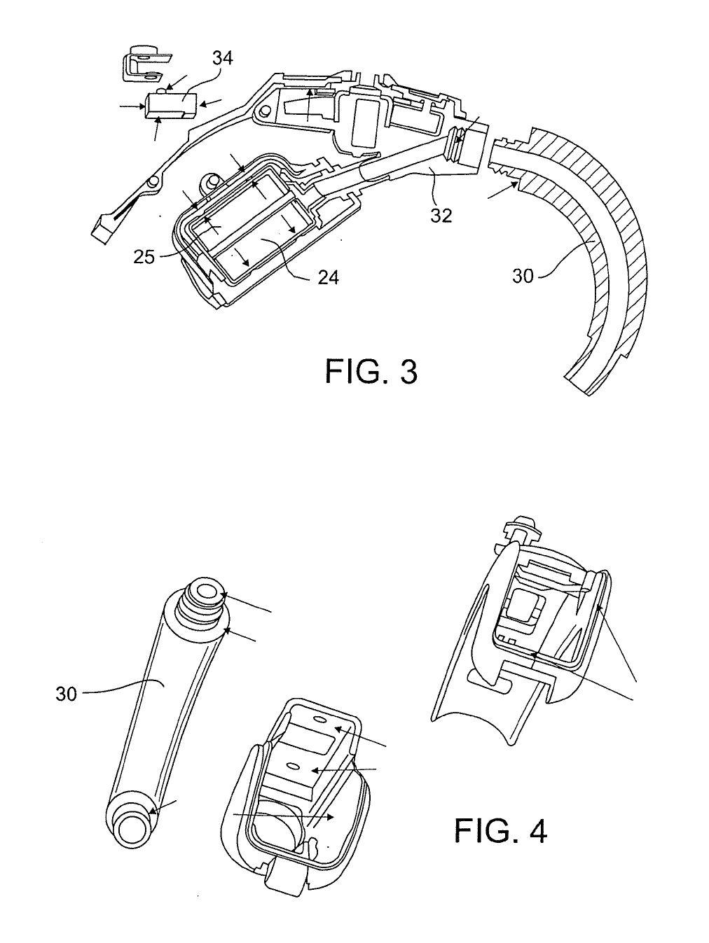

Any hearing aid component which requires seals and/or damping elements may be provided with a functional element applied by an inkjet printing process according to the invention. Examples of such components are shown in FIGS. 3 & 4. For example, both ends of a hearing aid ear-hook 30 may be provided with damping elements. Also, the end of a hearing aid housing part 32 designed to receive an end of the ear-hook 30 may be provided with a seal.

In FIG. 3, receiver housing parts 24, 25 are shown which may be provided with damping elements. Further, in FIG. 3, a manual control element 34 is shown which may be provided with seals. In addition, functional structures may be applied to the manual control element in such a manner that the outer side of the manual control element 34 feels soft to the user.

Preferably, the hearing aid is a BTE (behind-the-ear) or ITE (in-the-ear) hearing aid.

Inkjet printing processes also could be used to provide hearing instrument components with two-dimensional (i.e., thinner than 50 μm) surface coatings in order to impart certain surface properties to the respective hearing instrument component, such as to provide for a hydrophobic surface or for an electrically conductive surface. However, such processes do not form part of the present invention which relates to the generation of 3D functional structures on hearing aid components.

1. A method of manufacturing a hearing aid component (24, 25, 30, 32, 34), comprising:
providing a substrate component (23);
applying a functional structure (22), made of a viscoelastic material having a thickness of at least 50 μm, onto a surface of the substrate component by an inkjet printing process utilizing a jet of droplets (18) having a volume from 0.1 nl to 10 nl, wherein the hardness of the functional structure is lower than the hardness of the substrate component.

2. The method of claim 1, wherein the substrate component is a vibration sensitive or humidity sensitive component of a hearing aid.

3. The method of claim 1, wherein the substrate component is produced by an injection molding process.

4. The method of claim 1, wherein the surface of the substrate component (23) is treated prior to applying the functional structure (22).

5. The method of claim 4, wherein the treating of the surface of the substrate component (23) prior to applying the functional structure (22) comprises roughening of said surface.

6. The method of claim 4, wherein the treating of the surface of the substrate component (23) prior to applying the functional structure (22) comprises at least one of activating and conditioning by irradiation.

7. The method of claim 1, wherein, after applying the functional structure (22) onto a surface of the substrate component (23), the functional structure is cured by applying one of heat, gas and radiation.

8. The method of claim 1, wherein the surface of the substrate component (23) has a roughness with an Ra value of at least 12 prior to applying the functional structure (22).

9. The method of claim 1, wherein the hardness of the material of the functional structure (22) is from 10 to 80 ShoreA.

10. The method of claim 1, wherein the material of the functional structure (22) is at least one of a silicone compound, and an acryl material.

11. The method of claim 1, wherein the hardness of the material of the substrate component (23) is 10 to 3000 HV 3 if the material is a metal, and 1 to 10000 HV 0.01 if the material is a plastics material.

12. The method of claim 1, wherein the functional structure is has properties enabling it to act as a seal.

13. The method of claim 1, wherein the functional structure has properties enabling it to act as a vibration damping element (22).

14. The method of claim 1, wherein the functional structure has properties enabling it to act as a shock absorbing element (22).

15. The method of claim 1, wherein the component is one of a housing part (32) of the hearing aid, a part of a hearing aid ear-hook (30), a housing part (24, 25) of a hearing aid loudspeaker, a part of a manual hearing aid control element (34), a housing part of a hearing aid microphone, a part of an hearing aid circuitry, and a hearing aid audio shoe.

16. The method of claim 1, wherein the hearing aid is a behind-the-ear or in-the-ear hearing aid.
